(19) United States
(12) Patent Application Publication
(10) Pub. No.: US 2002/0116198 A1
(43) Pub. Date: Aug. 22, 2002

(54) Method for transmitting synchronization data in audio and/or video processing systems

(76) Inventor: Peter Gutwillinger, Podersdorf am See (AT)

Correspondence Address: Henry M. Feiereisen, Suite 3220, 350 Fifth Avenue, New York, NY, 10118, US

(21) Appl. No.: 10/080,379

(22) Filed: Feb. 20, 2002

(30) Foreign Application Priority Data
Feb. 22, 2001 (AT) A 280/2001

(51) Int. Cl. G10L 21/00

(52) U.S. Cl. 704/275

(57) ABSTRACT

A method for transmitting synchronization data in an audio and/or video processing system that supports digital two-channel audio transmission between a control center and at least one remote station is disclosed. The synchronization data include speech information and control information. The speech information is transmitted over a first channel and the control information is transmitted as an analog audio signal over the second channel of the two channel transmission path.

### CROSS-REFERENCES TO RELATED APPLICATIONS

This application claims the priority of Austrian Patent Application, Serial No. A 280/2001, filed Feb. 22, 2001, the subject matter of which is incorporated herein by reference.

### BACKGROUND OF THE INVENTION

The present invention relates to a method for transmitting synchronization data, including speech information and control information, from and/or to control centers for audio and/or video processing systems that support digital two-channel audio transmission.

Methods for transmitting synchronization data are of particular importance in digital audio transmission for controlling mixing consoles that are installed, for example, in control centers. However, such methods can also be used when incorporating control centers in existing audio and/or video processing systems, such as control rooms, control consoles, and control networks, as well as in general for implementing digital audio standards in control centers.

The increasing complexity of audio/video control systems makes it increasingly difficult to synchronize the individual stations of the control system. For larger productions, such as election reporting and the like, between approximately 70 and 125 field locations have to be connected centrally with a main control center and optionally through the main control with one another. The field locations can also be organized in a different circuit arrangement, for example, by routing signals through intermediate control center centers. In this case, a one-to-one connection to all the remote stations has to be guaranteed, meaning that a busy signal (all attempts to reach the control center fail) has to be avoided at all cost. The control center has to be able to respond to all requests from the remote stations and well as to provide information directly to all the remote stations.

For this purpose, a speech and a control channel is provided for synchronizing the individual stations which one another in addition to the channels that transmit useful data, i.e., data used for video/audio production, such as interviews and commentaries, life reports, etc. The control center station can communicate at any time with the remote stations via these two channels and hence transmit spoken commands and/or control information.

Various methods exist for synchronizing the remote stations or intermediate control center stations with the main control room. These can include a simple mixing console in which upon request from a remote station (which is transmitted via the control channel and can, for example, illuminate an optical indicator on the mixing console) a voice communication (speech channel) is established by activating the corresponding mixing console controllers. In other more complex setups, an audio matrix can include audio control consoles that provide automatic connection and apply as well as administer connection priorities.

The implementation of a suitable connection logic for synchronization of complex audio control setups is challenging for many manufacturers, who therefore typically acquire the connection logic from third parties for incorporation in the control centers. These control centers are connected, on one hand, to all the remote stations via synchronization channels which transmit synchronization data (voice and control information) and, on the other hand, to the control console where they control upon request the connection between the remote stations and the control center.

Standardized two-channel audio transmission methods (AES/EBU, AED3id) are currently in use for transmitting audio data (useful data) digitally, in particular spoken information (voice or speech channel) between the control center and the remote stations. Currently, separate lines are used for transmitting the control information (control channel) between the control center and the remote stations. Alternatively, the control information can be modulated onto the speech signal, or a dedicated data channel can be used, also referred to as user bit in the AES/EBU standard. Direct bits from the transmission protocol can also be used.

The first approach disadvantageously requires separate cabling which can significant increase the cost (the cost of cabling a conventional audio control systems are about 30% of the total cost of that system). In the second approach, where the control information is modulated onto the speech signal, separate components have to be included in the control console for demodulation. Finally, when using the user bit or direct bits from the transmission protocol for the control information, filters and sample rate converters may have to be inserted in the audio channels, for example between the control center and the remote stations. Sample rate converters may run into problems when the number of the transmitted sampled values and hence also the number of the binary data to be transmitted changes.

It would therefore be desirable and advantageous to provide a method for transmitting data which obviates the aforedescribed disadvantages and which facilitates transmission of the synchronization data (speech and control information) over existing wiring.

### SUMMARY OF THE INVENTION

According to an aspect of the invention, the audio information is transmitted over a first channel and the control information over a second channel of a two-channel audio transmission system. Since transmitting the speech information between the control center and the remote stations requires only a single (mono) audio channel for communication, the second channel in the two-channel audio transmission system can in this case be used for transmitting the control information. This obviates the need for separate wiring.

According to another feature of the invention, the control information can be transmitted in the form of an audio signal. This has the advantage that the second channel can be used for data transmission without requiring modifications.

According to another feature of the invention, existing and/or customary logic components or elements can be employed by incorporating the control information in digital form in the audio signal, for example, by using synchronous or asynchronous serial data transmission.

According to yet another feature of the invention, the two channels of the two-channel audio transmission system can be separated in the signal path, with the speech information being supplied to a signal processing unit and the control information to a data processing unit. With this arrangement, the control consoles can be constructed in modular form and/or novel control systems can be incorporated in existing digital audio processing systems.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic diagram showing the basic layout of an audio or video control system;

FIG. 2 is a schematic diagram of a data format employed with a digital two-channel audio transmission system operating according to the AES/EBU standard;

FIG. 3 is a schematic diagram of a sub-frame according to the AES/EBU standard;

FIG. 4 shows schematically a control information signal transmitted as part of an audio signal according to the invention; and

FIG. 5 shows schematically an exemplary device for signal transmission according to the invention.

### DETAILED DESCRIPTION OF PREFERRED EMBODIMENTS

Throughout all the Figures, same or corresponding elements are generally indicated by same reference numerals.

The invention relates to a system and method for transmitting synchronization data between remote stations and control centers, and more particularly to a simplified and space-saving method for transmitting these data.

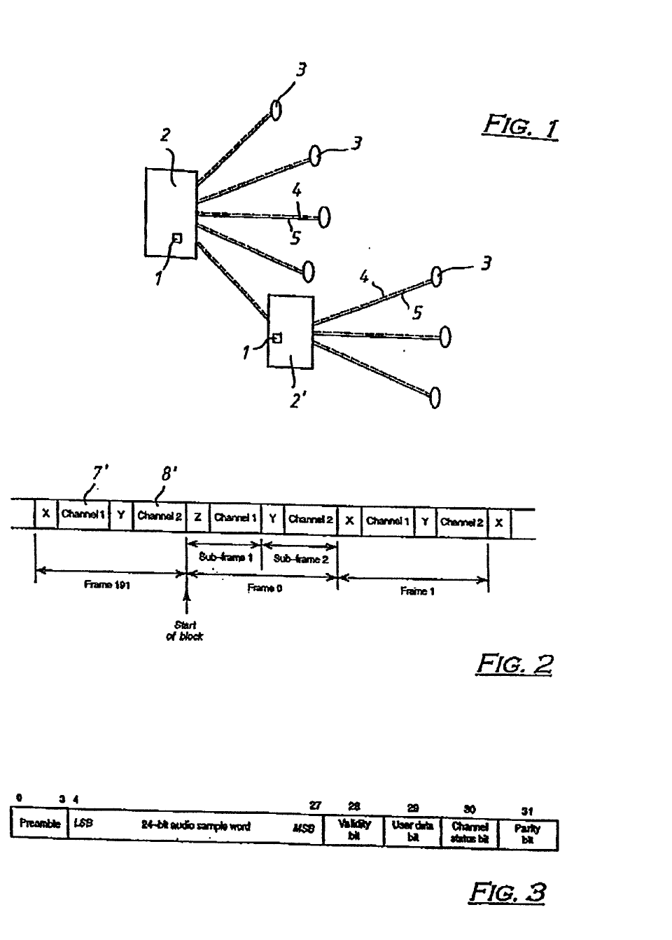

Turning now to the drawing, and in particular to FIG. 1, there is shown a basic layout of a control system for audio and/or video production, which includes a control center 2 as well as several remote stations 3 which transmit the useful data to be processed, such as the audio/video data from news reports with life feeds, via active lines 4 to the control center. Also possible are more elaborate configurations which include intermediate control center centers 2′ and/or even hierarchically or cyclically networked control systems. The control center 2 and the remote stations 3 and/or the intermediate control centers 2′ are hereby connected not only via the active lines 4 that transmit the useful data, but also via synchronization lines 5 for the purpose of synchronizing the various stations of the control system.

The synchronization lines 5 transmit, on one hand, speech information for direct communication between the control center 2 and the remote stations 3 (speech channel) and, on the other hand, control information for automatic synchronization (control channel). The synchronization lines 5 can include separate wiring for the speech and for the control information. Alternatively, the control information can be modulated onto the speech signal, thereby obviating the need to provide separate wiring for the control information.

The control information can be transmitted to a command center 1 which can be located proximate to the control center 2 and controls, for example, an audio/video control console 12.

The useful audio data in conventional digital audio and/or video processing systems are typically transmitted through two-channel digital audio transmission systems. These systems conform to international standards, such as a AES/EBU standard for digital transmission of audio data. When using the AES/EBU standard, the audio data are preferably sampled at a frequency between 32 kHz and 48 kHz and transmitted in digital form. The two channels 7′, 8′ are sampled simultaneously and transmitted in time-division-multiplexing over the same wires. FIGS. 2 and 3 show the protocol and the data structure, respectively, for this standard. An exemplary data frame (Frame 0) consists of two sub-frames (Sub-Frame 1, Sub-Frame 2) which represent the audio level actually encoded in a respective channel. The first sub-frame has a prefix “X” and the second sub-frame has a prefix “Y”. For providing status information in the channel, the first sub-frame after every 192^{nd} frame starts with “Z” instead of “X” (FIG. 2). The internal structure of an exemplary sub-frame is depicted in FIG. 3. In this example, 24 bits are available for encoding the audio level.

The speech information, which represents the portion of the synchronization data that provides the direct voice communication between the control center 2 and the remote stations 3, can also be transmitted via a digital two-channel audio transmission system. Because a stereo signal is not required for this application, the second channel 8′ in this transmission system can be used for other purposes.

According to the invention, the second channel 8′ (see FIG. 2) which is not required if only speech is transmitted, is used for transmitting the control information. Accordingly, the speech information (speech channel 7) is transmitted in the first channel 7′, and the control information (control channel 8) is transmitted in the second channel 8′.

Referring now to FIG. 4, the control information can have the form of a serially transmitted digital signal, representing, for example, serially transmitted synchronous or asynchronous data. Each discrete time interval Δ (see FIG. 4) of the time-discrete digital signal represents one bit of information. For example, the signal depicted in FIG. 4 can represent the following sequence of digits (RS 232 standard): “11110010001 . . . ”. Unlike conventional transmission methods, where only the audio signals are transmitted as analog signals, with the method of the invention, this digital control information is also transmitted as an analog audio signal, i.e., as a continuous temporal function. The control signal can therefore be transmitted in the sub-frame referred to as “24-bit audio sample word” in FIG. 3. Accordingly, both signals can be transmitted via conventional signal paths, i.e., signal paths adapted to transmit audio signals.

Because with the AES/EBU standard the audio data are sampled and transmitted to an analog-digital converter, there exists a critical ratio between the sampling rate and the transmission rate of the control information. If the selected time interval A is too short, then a signal can no longer be sampled and/or reconstructed error-free. With a typical transmission rate of up to 9600 Baud for the control information and a minimum sampling rate of 32 kHz, approximately three sampled values are available for the representation of a bit.

When transmitting the control information in the form of an audio signal, sample rate converters connected between the individual stations of the control system can advantageously be used. Sample rate converters which are frequently required in larger control systems, change the sampling rate of the signals in the signal path. However, when using the user bit for transmitting the control information, as provided in the AES/EBU standard, the sample rate converters can cause problems, because the temporal characteristic of the transmitted bits is subject to change. The method of the invention eliminates this problem, because the waveform of the audio signal is not influenced by interposed sample rate converters.

Moreover, the level standard between the individual components of the different stations of the control system can be easily matched as long as a minimum level is maintained for the logic components in the control system.

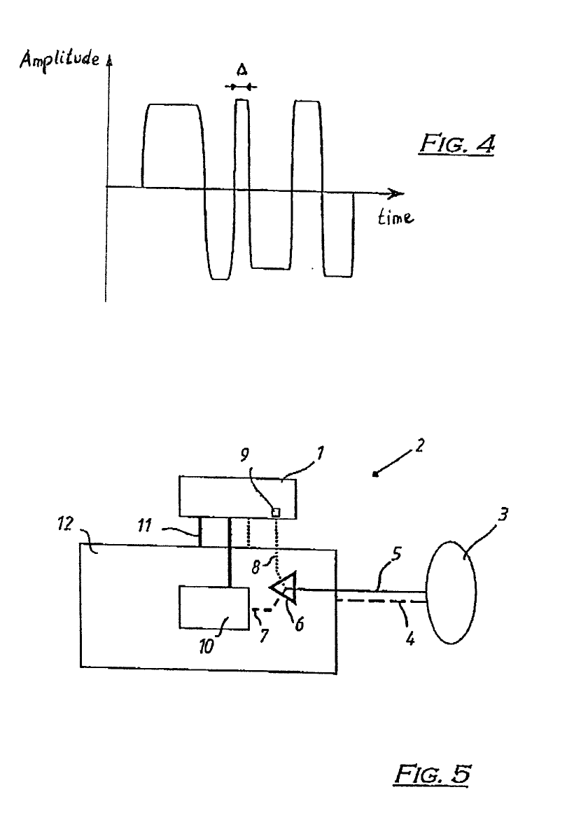

The layout of a device for transmitting data according to the invention is shown schematically in FIG. 5. Audio and/or video data are transmitted from a remote stations 3 via active lines 4 to the control center. At the same time, the speech channel 7 and the control channel 8 which provides synchronization between all stations of the control system, are transmitted via the synchronization lines 5 between the control center 2 and a remote station 3. The two channels (speech channel 7 and control channel 8) propagating in the synchronization lines 5 are separated with a splitter 6 near the control console 12. The splitter 6 is of conventional design and not part of the invention. After the channels are separated, the speech information is supplied to a signal processing unit 10 and control information is supplied to a separate data processing unit 9. Alternatively, both channels of the synchronization lines 5 can be supplied to the signal processing 10 and the data processing 9, respectively, without using a splitter. In this case, the unused portion of the respective signals have to be removed later. The two channels can also be separated at other locations in the signal path. This can be advantageous, for example, when a command center is placed at a location separate from the control console 12, for example, between the remote station 3 and the control center 2. In this case, the two channels can advantageously be separated in or near the command center 1 itself.

The signal processing unit 10 can include various filters and/or audio mixers and is shown in FIG. 5 as being integrated in a control table 12. With this arrangement, the voice communication to each remote station 3 can be adapted to the specific situation of the remote station 3. For example, in the simplest case, the sound level of loud speech sources can be easily adjusted.

The data processing unit 9 can be integrated in the external command center 1. However, the command center 1 and the mixing or control console 12 can also be combined in a single unit. The schematically depicted modular construction is particularly advantageous, since in this case additional command centers 1 can be easily integrated into existing digital audio processing systems.

The data processing unit 9 uses the data of the control channel 8 in a conventional manner for synchronizing the audio control system. In the simplest case, upon request by a remote station 3, a voice/speech connection is established between the control center 2 and the respective remote station 3. The design of the control logic and the data processing unit 9 depends on the particular system and is therefore not part of the invention. However, it is understood that the control information should be transmitted using the method of the invention.

Referring now to the embodiment illustrated in FIG. 5, the signal processing unit 10 can be controlled by the data processing unit 9. In this way, a major portion of the connection logic can be removed from the command center 1. The data processing unit 9 or the command center 1 control the audio and/or video processing system (e.g., for providing the afore-described voice connection) and/or the control console or the signal processing unit 10 via a control connection 11. However, the specific design of the control connection 11 is not part of the invention. Accordingly, this connection can be based on a conventional standard, such as MADI (multi-channel audio digital interface) or can be based on a proprietary solution.

The control connection 11 is preferably bi-directional, so that the data processing unit 9 can also receive the control commands sent by the control console 12.

For synchronizing the stations of the control system, control information is also transmitted in the opposite direction from the control center 2 to the remote stations 3. The control information is generated or formatted in the data processing unit 9 of the command center 1 in conformance with the settings on the control console 12. This provides a bi-directional connection for synchronization and control between the control center 2 and the remote stations 3. By having the data processing unit 9 generate the control information that is sent back to the remote stations 3, complex responses to received queries from the remote stations 3 are possible.

Finally, in response to a query from a remote station 3, both the speech information and control information can be sent back to the remote station 3. The data generated in the data processing unit 9 together with the output of the signal processing unit 10 and/or with new speech information in the first channel 7′ (speech channel 7) are transmitted in analog form over the second channel 8′ (control channel 8) to the remote stations 3, i.e., to the original source of the control information or to other users. In this case, the other users must also support the data transmission method according to the invention.

While the invention has been illustrated and described as embodied in a method for transmitting synchronization data in audio and/or video processing systems, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A method for transmitting synchronization data in an audio and/or video processing system that includes a digital two-channel audio transmission path between a control center and at least one remote station, said synchronization data including speech information and control information, said method comprising the steps of:
transmitting the speech information over a first channel of the two-channel transmission path; and
transmitting the control information over the second channel of the two-channel transmission path.

2. The method of claim 1, wherein the control information is transmitted in form of an audio signal.

3. The method of claim 2, wherein the control information transmitted by the audio signal is in digital form.

4. The method of claim 3, wherein the digital control information comprises serially transmitted synchronous or asynchronous data.

5. The method of claim 1, and further comprising the steps of separating the first channel and the second channel transmitted over the two-channel transmission path; and supplying the speech information to a signal processing unit, and supplying the control information to a data processing unit.
